(19) United States
(12) Patent Application Publication
(10) Pub. No.: US 2023/0132826 A1
(43) Pub. Date: May 4, 2023

(54) METHOD AND WIRELESS NETWORK FOR MANAGING CHANNEL STATE INFORMATION (CSI) FEEDBACK COMPRESSION IN WIRELESS NETWORK

(71) Applicant: Samsung Electronics Co., Ltd., Suwon-si (KR)

(72) Inventors: Karthik MURALIDHAR, Bangalore (IN); Dattaraj Dileep Raut MULGAONKAR, Bangalore (IN); Diwakar SHARMA, Bangalore (IN); Eko Nugroho ONGGOSANUSI, Coppell, TX (US); Md Saifur RAHMAN, Plano, TX (US)

(21) Appl. No.: 18/052,521

(22) Filed: Nov. 3, 2022

(30) Foreign Application Priority Data
Nov. 3, 2021 (IN) 202141050461
Oct. 27, 2022 (IN) 2021141050461

(51) Int. Cl. H04B 7/06; H04L 25/02

(52) U.S. Cl. CPC H04B 7/0663; H04B 7/0626; H04L 25/0242; H04B 7/0639

(57) ABSTRACT

The disclosure relates to a 5G or 6G communication system for supporting a higher data transmission rate. Embodiments herein disclose methods for managing CSI feedback compression in wireless network by base station. The method includes transmitting at least one pilot symbol over first window. The method includes receiving at least one of a first and second type feedback from a UE at an end of the first window or after the first window. The method includes receiving the compressed CSI feedback based on predefined precoder weights in the first window. The method includes computing and predicting at least one precoder weight for the UE in at least one time instant in a second window for at least one sub-band of the UE based on the at least one of the first and second type feedback. The method includes managing the received CSI feedback compression based on the predicted precoder weight.

### CROSS REFERENCE TO RELATED APPLICATIONS

This application is based on and claims priority under 35 U.S.C. § 119 to Indian Provisional Patent Application No. 202141050461, filed on Nov. 3, 2021, and Indian Non-Provisional Patent Application No. 202141050461 filed on Oct. 27, 2022, in the Indian Intellectual Property Office, the disclosure of which is incorporated by reference herein in its entirety.

### BACKGROUND

### 1. Field

Embodiments disclosed herein relate to wireless communication networks, and more particularly to managing channel state information (CSI) feedback compression in a Doppler domain in the wireless communication networks.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Release 16 for CSI feedback reduces overhead compared to Release 15 by doing compression across sub bands. Release 18 speaks about CSI feedback for mobility. For mobility scenarios, it is possible to attain further compression in time (i.e., Doppler domain).

The principal object of the embodiments herein is to disclose methods and an apparatus for managing CSI feedback compression in a Doppler domain in wireless communication networks.

### SUMMARY

Accordingly, the embodiments herein provide methods for managing a channel state information (CSI) feedback compression in a wireless network. The method includes transmitting, by a base station, at least one pilot symbol over a first window. Further, the method includes receiving, by the base station, at least one of a first type feedback and a second type feedback from a user equipment (UE) at an end of the first window or after the first window. Further, the method includes receiving, by the base station, a compressed CSI feedback based on predefined precoder weights in the first window or a second window. Further, the method includes computing and predicting, by the base station, at least one precoder weight for the UE in at least one time instant in the second window for at least one sub-band of the UE based on the at least one of the first type feedback and the second type. Further, the method includes managing, by the base station, the received CSI feedback compression in the second window based on the at least one predicted precoder weight.

In an embodiment, computing and predicting, by the base station, the at least one precoder weight for the UE in the at least one time instant in the second window for the at least one sub-band of the UE based on the at least one received feedback information includes extracting, by the base station, information from the second type feedback, and predicting, by the base station, the at least one precoder weight for the UE in at least one time instant in the second window for the at least one sub-band of the UE based on the extracted information.

In an embodiment, the at least one of the first type feedback and the second type feedback depends on a prior configuration of the UE from the base station and a prior signalling from the UE to the base station.

In an embodiment, the at least one first type feedback corresponds to all precoder weights across time instants in the first window for all sub-bands of the UE.

In an embodiment, the first window is an observation window, and the second window is a prediction window.

In an embodiment, the at least one pilot symbol comprises a channel state information reference signal (CSI-RS), wherein the CSI feedback compression is managed in a Doppler domain.

In an embodiment, the at least one precoder weight for the UE is predicted in the second window based on at least one of a linear prediction technique, a spectral estimation technique and a neural network (NN).

In an embodiment, the second type feedback is determined by computing the channel across the selected time instant in the first window for at least one delay or sub-band or sub-carrier or beam delay, predicting the channel using the computed channel in the first window across the selected time instant in the second window for at least one delay or sub-band or sub-carrier or beam delay, wherein the channel across the selected time instant in the second window for the at least one delay or the sub-carrier or the sub-band or the angle delay is predicted based on at least one of a liner prediction technique, a spectral estimation technique and a neural network (NN), computing precoder for the selected time instant in the second window for all the sub-bands of the UE, and obtaining, by the base station, at least one precoder weight across the selected time instant in the second window for all the sub-bands of the UE in a compressed format.

In an embodiment, the second type feedback is determined by predicting the precoder across the selected time instant in the second window for at least one delay or sub-band, wherein the precoder across the selected time instant in the second window are predicted from precoders in first window for the at least one delay or the sub-band is predicted based on at least one of a liner prediction technique, a spectral estimation technique and a neural network (NN), obtaining, by the base station, at least one precoder weight across the selected time instant in the second window for all the sub-bands of the UE in a compressed format.

Accordingly, the embodiments herein provide methods for managing a CSI feedback compression in a wireless network. The method includes estimating, by an apparatus, at least one channel for one of a set of sub-carriers or at least one sub-band or at least one delay or at least one beam delay for a selected time instant in a first window. Further, the method includes estimating, by the apparatus, at least one precoder weight for the selected time instant across the at least one sub-band or delay for the selected time instant in the first window. Further, the method includes predicting, by the apparatus, a value of a quantity in the selected time instant across at least one sub-band or the delay in a second window based on a linear combination or a non-linear combination of quantities in one or more dimensions in the first and/or second window, wherein the linear combination or non-linear combination (learning coefficient) is learned across a plurality of candidate values in the first window. Further, the method includes managing, by the apparatus, the CSI feedback compression in the wireless network based on the predicted value of the quantity.

In an embodiment, the quantity is a channel corresponding to at least one of subcarriers, sub-bands, a frequency, delays, beam delays and antenna. In another embodiment, the quantity is the precoder weight for the beam in a subband or delay. If the quantity is channel, the dimension could be subcarrier/frequency/sub-bands/antennas/delays/beams. If the quantity is an element of w2, the dimensions could be associated beams/sub-bands. If the quantity is an element of w2˜, the dimensions could be associated beams/delays. In an embodiment, the apparatus comprises at least one of a user equipment (UE) and a base station.

Accordingly, the embodiments herein provide methods for managing a CSI feedback compression in a wireless network. The method includes estimating, by an apparatus, at least one channel for a set of sub-carriers or at least one sub-band or delays or beam delays for a selected time instant in a first window. Further, the method includes estimating, by the apparatus, at least one precoder weight for the selected time instant across the at least one sub-band or delay for the selected time instant in the first window. Further, the method includes determining, by the apparatus, an output over a period of time in a second window by performing spectral estimation associated with a quantity in the first window, where the output of the spectral estimation is an n-dimensional frequency component and an amplitude associated with the n-dimensional frequency component. Further, the method includes estimating, by the apparatus, a value of the quantity in the selected time instant in the second window based on the output. Further, the method includes managing, by the apparatus, the CSI feedback compression in the wireless network based on the estimated value of the quantity.

In an embodiment, if the quantity is an element of w2 and n=1, a frequency component is across the time, wherein if the quantity is an element of w2 and n=2, a frequency component is across the sub-bands and time, wherein if the quantity is an element of w2˜ and n=1, a frequency component is across the time. If the quantity is an element of w2 and n=2, a frequency component is across the delay and time, wherein if the quantity is channel at a subcarrier/sub-band and n=1, the frequency component is across the time wherein if the quantity is channel at a subcarrier/sub-band and n=2, the frequency component is across the time and the subcarrier/sub-band, wherein if the quantity is channel at a delay and n=1, the frequency component is across the time, wherein if the quantity is channel at a delay and n=2, the frequency component is across the time and delay, and wherein if the quantity is channel at a delay, angle, and n=1, the frequency component is across the time.

Accordingly, the embodiments herein provide methods for managing a CSI feedback compression in a wireless network. The method includes compressing, by a UE, at least one precoder at various time instants across sub-bands or delays at the UE in at least one of a first window and a second window. Further, the method includes sending, by the UE, at least one compressed precoder to a base station.

In an embodiment, further, the method includes computing, by the UE, a vector value corresponding to precoder weights of a beam, a delay across selected time instants in at least one of the first window or and the second window. Further, the method includes determining, by the UE, that computed vector value for all delays for the beam are completed. Further, the method includes determining, by the UE, that computed vector value for all beams are completed. Further, the method includes determining, by the UE, whether a time domain Doppler basis matrix for the selected time instants is different across one of a spatial domain, a frequency domain and a delay domain.

In an embodiment, the method includes feedbacking a first compressed Doppler coefficient precoder vector value based on precoder weights for each beam and subband or delay across the selected time instants, a Doppler-time domain basis matrix for each beam and subband or delay associated with the first compressed vector and a spatial beam matrix value associated with all beams value in response to determining that the time domain Doppler basis matrix is different across one of the spatial domain, the delay domain and the frequency domain.

In another embodiment, the method includes feedbacking a first compressed Doppler coefficient precoder matrix value based on precoder weights for all beams and subband/delay across the selected time instants, a joint Doppler-time frequency/delay domain basis matrix for all beams and subband/delay associated with the first compressed Doppler coefficient matrix and a spatial beam matrix value associated with all beams to the base station in response to determining that the time domain Doppler basis matrix is not different across one of the spatial domain, the delay domain and the frequency domain.

Accordingly, the embodiments herein provide a base station including a CSI controller coupled with a processor and a memory. The CSI controller is configured to transmit at least one pilot symbol over a first window and receive at least one of a first type feedback and a second type feedback from a UE at an end of the first window or after the first window. Further, the CSI controller is configured to receive a compressed CSI feedback based on predefined precoder weights in the first window or a second window and compute and predict at least one precoder weight for the UE in at least one time instant in the second window for at least one sub-band of the UE based on the at least one of the first type feedback and the second type feedback. Further, the CSI controller is configured to manage the received CSI feedback compression based on the at least one predicted precoder weight in the second window.

Accordingly, the embodiments herein provide an apparatus including a CSI controller coupled with a processor and a memory. The CSI controller is configured to estimate at least one channel for one of a set of sub-carriers or at least one sub-band or at least one delay or at least one beam delay for a selected time instant in a first window. Further, the CSI controller is configured to estimate at least one precoder weight for the selected time instant across the at least one sub-band or delay for the selected time instant in the first window.

Further, the CSI controller is configured to predict a value of a quantity in the selected time instant across at least one sub-band or delay in a second window based on a linear combination or a non-linear combination (learning coefficient) of quantities in one or more dimensions in the first and/or second window, wherein the linear combination learning coefficient is learned across a plurality of candidate values in the first window, wherein the linear combination learning coefficient corresponds to quantities in one or more dimensions in the first window. Further, the CSI controller is configured to manage the CSI feedback compression in the wireless network based on the predicted value of the quantity.

Accordingly, the embodiments herein provide an apparatus including a CSI controller coupled with a processor and a memory. The CSI controller is configured to estimate at least one channel for a set of sub-carriers or at least one sub-band or delays or beam delays for a selected time instant in a first window. Further, the CSI controller is configured to estimate at least one precoder weight for the selected time instant across the at least one sub-band or delay for the selected time instant in the first window.

Further, the CSI controller is configured to determine an output over a period of time in a second window by performing spectral estimation associated with a quantity in the first window, where the output of the spectral estimation is an n-dimensional frequency component and an amplitude associated with the n-dimensional frequency component. Further, the CSI controller is configured to estimate a value of the quantity in the selected time instant in the second window based on the output. Further, the CSI controller is configured to manage the CSI feedback compression in the wireless network based on the estimated value of the quantity.

Accordingly, the embodiments herein provide a UE including a CSI controller coupled with a processor and a memory. The CSI controller is configured to compress at least one precoder at various time instants across sub-bands or delays at the UE in at least one of a first window and a second window. Further, the CSI controller is configured to send at least one compressed precoder to a base station.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a wireless network for managing a CSI feedback compression according to embodiments as disclosed herein;

FIG. 2 illustrates an example of hardware components of an apparatus (i.e., UE or base station) according to the embodiments as disclosed herein;

FIG. 3 illustrates an example of a mode of operation according to embodiments as disclosed herein;

FIG. 4A and FIG. 4B illustrate examples of LCP according to embodiments as disclosed herein;

FIG. 4C illustrates ab example of 2D-LCP according to embodiments as disclosed herein;

FIG. 5 illustrates an example of the process of computing Doppler coefficients according to embodiments as disclosed herein;

FIG. 6 illustrates an example of the low frequency Doppler delay components in a 2D frequency grid according to embodiments as disclosed herein;

FIG. 7 illustrates a flow chart of a method for managing the CSI feedback compression in the wireless network according to embodiments as disclosed herein;

FIG. 8 illustrates an example flow chart of a method for managing the CSI feedback compression in the wireless network according to embodiments as disclosed herein;

FIG. 9 illustrates an example flow chart of a method for determining a first feedback type while managing the CSI feedback compression in the wireless network according to embodiments as disclosed herein;

FIG. 10 illustrates an example flow chart of a method for determining a second feedback type while managing the CSI feedback compression in the wireless network according to embodiments as disclosed herein;

FIG. 11 and FIG. 12 illustrate example flow charts of a method for determining a precoder weights while managing the CSI feedback compression in the wireless network according to embodiments as disclosed herein;

FIG. 13 illustrates an example flow chart of a method for managing the CSI feedback compression in the wireless network using a linear prediction according to embodiments as disclosed herein;

FIG. 14 illustrates an example flow chart of a method for managing the CSI feedback compression in the wireless network using a spectral estimation according to embodiments as disclosed herein;

FIG. 15 illustrates an example flow chart of a method for managing the CSI feedback compression in the wireless network using Doppler-delay coefficients according to embodiments as disclosed herein; and

FIG. 16 illustrates an example flow chart of a method for managing the CSI feedback compression in the wireless network using the non-linear prediction or a neural network according to embodiments as disclosed herein.

### DETAILED DESCRIPTION

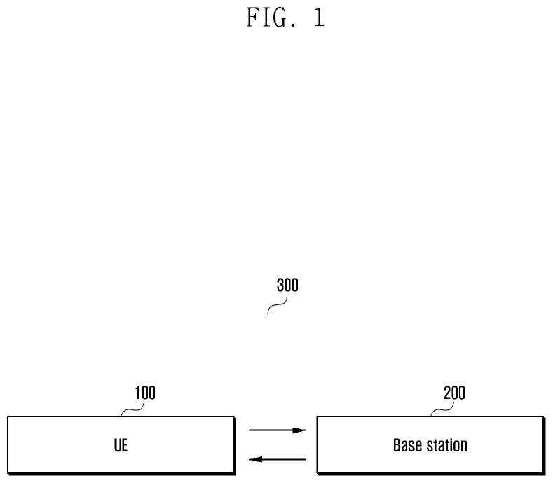

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods for managing a CSI feedback compression in a wireless network. The method includes transmitting, by a base station, at least one pilot symbol over a first window. Further, the method includes receiving, by the base station, at least one of a first type feedback and a second type feedback from a UE at an end of the first window or after the first window. Further, the method includes receiving the compressed CSI feedback based on predefined precoder weights in the first window or a second window. Further, the method includes computing and predicting, by the base station, at least one precoder weight for the UE in at least one time instant in the second window for at least one sub-band of the UE based on the at least one of the first type feedback and the second type feedback. Further, the method includes managing, by the base station, the received CSI feedback compression based on the at least one predicted precoder weight in the second window.

The methods can be used for managing the CSI feedback compression in the Doppler domain. As in Doppler scenarios feedback is increased, a compressed mechanism ensures the amount of feedback is greatly reduced and compression works as the feedback is highly correlated due to the Doppler scenario.

Referring now to the drawings, and more particularly to FIGS. 1 through 16, where similar reference characters denote corresponding features consistently throughout the figures, there are shown at least one embodiment.

The following notifications have been used in the patent disclosure:
a) Matlab notation to access matrices/vectors;
b) An estimate of a quantity x is denoted by \hat{x};
c) A quantity x approximated due to quantization is denoted by x̅;
d) Matrices will be uppercase BOLD, vectors lower case bold and scalars are normal fonts; and
e) ‘*’ denotes conjugate.

The W₂ matrix is compressed across subbands and is feedback to the base station. Assuming a system with N₃ subbands and 2L SD beams, the frequency domain correlation inside W₂ can be exploited by applying DFT compression on top of W₂ which is of size 2L×N₃.

A frequency compression matrix of size N₃×M, W_{f} is selected from the columns of an oversampled DFT codebook, where the matrix forms an orthogonal subset of the basis set found in the DFT codebook.

M<N₃ is the number of frequency domain (FD) basis vectors, that are selected after compression. FD compression is applied to each layer l to obtain a matrix of linear combination coefficients W₂:

\tilde{W}₂=W₂W_{f} (4).

W_{f} can be regarded as the equivalent of the 2N₁N₂×2L matrix W₁ for frequency compression. The final precoder format can be written as:

W=W₁\tilde{W}₂W_{f}^{H} (5).

The elements inside \tilde{W}₂ are referred to as FD coefficients.

Only one Rx antenna, or a rank 1 CSI-Type 2 feedback assumed for simplicity and ease of depiction though it can apply easily for higher ranks.

The feedback is W₂, \tilde{W}₂. The problem for the simple case of feedback of channel coefficients across time and frequency is first formulated. Based on the motivation of these approaches, these approaches can be extended to the case where elements of W₂, \tilde{W}₂ are fed back.

### Linear Prediction:

It is well known that channels in time and frequency are governed by prediction coefficients. In the simplest case, a future channel value in time domain is a linear combination (using linear prediction coefficients) of past channel values. The error in prediction is much lesser than the error between a current and previous value. So to feedback values of lesser magnitude may result in lesser overhead. The linear predictor coefficients are provided as feedback.

In one embodiment, Doppler components are provided as shown below.

Just as the frequency-selective channel varies slowly and as such can be quite accurately represented by a few FFT bins (if FFT is taken of the channel across frequency), the same holds for channel variation across time. If there are N values across time of the channel and if N-point FFT is taken, the channel can be quite accurately reconstructed using a few (a) FFT bins (lesser than N). These a FFT bins can be learnt using a subset N₁<N and N₁>a samples. Once the a FFT bins are learnt, the remaining N−N₁ samples can be reconstructed based on these bins. If done on multipaths in a time domain, it is called as delay-Doppler model.

In one embodiment, Kalman filter is provided as shown below.

Kalman filter does a MMSE estimate of a noisy signal, if the variation of the signal is captured in a state equation. Kalman filter can have the linear channel predictor coefficients (LCP) as part of the state equation. LCP can predict a future channel value and the Kalman filter can correct the predicted value thereby minimising the error. The Kalman filter works with Noisy observations. The feedback is quantized, so the channel reconstructed at the BS is a noisy version of the true channel. The Kalman filter can give better estimate of the downlink channel. For this the error variance of linear prediction, LCP and error variance due to the quantization need to be provided as feedback. The base station need not work with quantized channel values, instead the base station may work with more accurate values, mainly to reduce quantization noise (if that has an impact).

FIG. 1 illustrates a wireless network (300) for managing a CSI feedback compression according to embodiments as disclosed herein. The wireless network (300) can be, for example, but not limited to a long-term evolution (LTE) network, a fifth generation (5G) network, an open radio access network (ORAN) network or the like. The wireless network (300) includes a UE (100) and a base station (200). The UE (100) can be, for example, but not limited to a smart laptop, a smart computer, a smart device-to-device (D2D) device, a smart vehicle to everything (V2X) device, a smartphone, a smart foldable phone, a smart TV, an immersive device, an internet of things (IoT) device or the like. The base station (200) is also referred as a gNB, an eNB, a new radio (NR) base station or the like.

In an embodiment, the base station (200) transmits a pilot symbol (e.g., CSI-RS or the like) over a first window (e.g., observation window or the like). Further, the base station (200) receives at least one of a first type feedback and a second type feedback from the UE (100) at an end of the first window or after the first window.

In an embodiment, the second type feedback is determined by computing the channel across the selected time instant in the first window for at least one delay or sub-band or sub-carrier or beam delay, predicting a channel using the computed channel in the first window across a selected time instant in a second window (e.g., prediction window or the like) for at least one delay or sub-band or sub-carrier or beam delay, computing a precoder for the selected time instant in the second window for all the sub-bands of the UE (100), and obtaining at least one precoder weight across the selected time instant in the second window for all the sub-bands of the UE (100). The channel across the selected time instant in the second window for the at least one delay or the sub-carrier or the sub-band or the angle delay is predicted based on at least one of a liner prediction technique, a spectral estimation technique and a neural network (NN).

In another embodiment, the second type feedback is determined by predicting the precoder across the selected time instant in the second window for at least one delay or sub-band, and obtaining at least one precoder weight across the selected time instant in the second window for all the sub-bands of the UE (100). The precoder across the selected time instant in the second window for the at least one delay or the sub-band is predicted from precoders in the first window based on at least one of the liner prediction technique, the spectral estimation technique and the NN.

At least one of the first type feedback and the second type feedback depends on the prior configuration of the UE (100) from the base station (200) and a prior signalling from the UE (100) to the base station (200). The at least one first type feedback corresponds to all precoder weights across time instants in the first window for all sub-bands of the UE (100). The at least one precoder weight for the UE (100) is predicted based on at least one of the linear prediction technique, the spectral estimation technique and the NN.

Based on the at least one received feedback information, the base station (200) computes and predicts at least one precoder weight for the UE (100) in at least one time instant in the second window (e.g., prediction window or the like) for at least one sub-band of the UE (100). In an embodiment, the base station (200) extracts information from the second type feedback and predicts the at least one precoder weight for the UE (100) in at least one time instant in the second window for the at least one sub-band of the UE (100) based on the extracted information.

Based on the at least one predicted precoder weight in the second window, the base station (200) manages the received CSI feedback compression. The CSI feedback compression is managed in a Doppler domain.

In another embodiment, the apparatus (e.g., UE (100), base station (200) or the like) estimates the at least one channel for one of a set of sub-carriers or at least one sub-band or at least one delay or at least one beam delay for a selected time instant in the first window. Further, the apparatus estimates at least one precoder weight for the selected time instant across the at least one sub-band or delay for the selected time instant in the first window. Further, the apparatus predicts a value of a quantity in the selected time instant in a second window across at least one sub-band or delay based on a linear combination (learning coefficient) or a non-linear combination (learning coefficient) of quantities in one or more dimensions in the first and/or second window. The linear combination or non-linear combination is learned across a plurality of candidate values in the first window. Based on the predicted value of the quantity, the apparatus manages the CSI feedback compression in the wireless network (300).

In another embodiment, the apparatus estimates the at least one channel for a set of sub-carriers or at least one sub-band or delays or beam delays for the selected time instant in the first window. Further, the apparatus estimates the at least one precoder weight for the selected time instant across the at least one sub-band or delay for the selected time instant in the first window. Further, the apparatus determines an output over a period of time in a second window by performing spectral estimation associated with a quantity in the first window. The output of the spectral estimation is an n-dimensional frequency component and an amplitude associated with the n-dimensional frequency component. Based on the output, the apparatus estimates a value of the quantity in the selected time instant in the second window. Based on the estimated value of the quantity, the apparatus manages the CSI feedback compression in the wireless network (300).

In another embodiment, the UE (100) compresses the at least one precoder at various time instants across sub-bands or delays at the UE (100) in at least one of the first window and the second window. Further, the UE (100) sends the at least one compressed precoder to the base station (200).

Further, the UE (100) computes a vector value corresponding to precoder weights of the beam, the delay and the doppler coefficient across selected time instants in at least one of the first window or and the second window. Further, the UE (100) determines that the computed vector value for all delays for the beam are completed and all beams are completed. Further, the UE (100) determines whether a time domain Doppler matrix is different across one of a spatial domain, a delay domain and a frequency domain. In response to determining that the time domain Doppler matrix is different across one of the spatial domain, the delay domain and the frequency domain, the UE (100) feedbacks a compressed Doppler coefficient precoder vector value based on precoder weights for each beam and subband or delay across the selected time instants, a Doppler-time domain basis matrix for each beam and subband or delay associated with the first compressed vector and a spatial beam matrix value associated with all beams.

In response to determining that the time domain Doppler matrix is not different across one of the spatial domain, the delay domain and the frequency domain, the UE (100) feedbacks the first compressed Doppler coefficient precoder matrix value based on precoder weights for all beams and subband/delay across the selected time instants, a joint Doppler-time frequency/delay domain basis matrix for all beams and subband/delay associated with the first compressed Doppler coefficient matrix and a spatial beam matrix value associated with all beams.

### Mode of Operation:

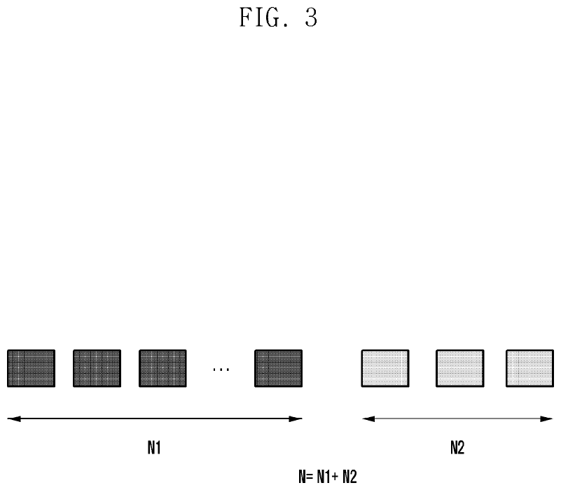

FIG. 3 illustrates an example of the mode of operation. Here N₁ samples belong to first or observation window and N₂ samples belong to second or prediction window. Consider that N=N₁+N₂. In N₁, feedback is sent as per Rel. 16. During this time, the UE (100) calculates LCP/error variance of LCP, quantization error variance/Doppler coefficients etc. At point A, the UE (100) feeds back LCP/error variance of LCP, quantization error variance/Doppler coefficients to the BS (200). This time instant is called as feedback point or FP. During N₂, the feedback is provided using embodiments as disclosed herein. CSI-RS is sent over N₁ and N₂ regions (samples).

### Linear Channel Prediction:

Let H(f,n;a) be the channel at frequency location f and time instant n. The sampling instants can be anything in time and frequency. For example f could be once every RB/subband and n could be once every slot/10 slots. It corresponds to ath Tx antenna. For simplicity throughout one Rx antenna is assumed. Let hₗ(n;a) be the lth multipath time domain component at time instant n and ath Tx antenna. H(n;a) be the vector of stacked up H(f,n;a) for various f and h(n;a) be the vector of stacked up hi(n;a) for various l. Let F be the sampled FFT matrix with rows corresponding to indices of f and columns corresponding to indices of l. H(n;a)=F h(n;a). Assume length of H(n;a)>length of h(n;a). hₗ(n;a)=[hₗ(n−P+1;a) . . . hₗ(n;a)] is defined, where P is order of prediction and a is a P×1 vector of LPC coefficients (assumed, for simplicity, to be same across Z multipaths).

In one embodiment, a linear channel prediction (1D) and training are provided as shown below.

The coefficient vector a is learnt. Happens in the first N₁ time instants. The training equation to learn a is

$$[ \begin{matrix}{h}_{l} ( n ; a ) \\ {h}_{l} ( n - 1 ; a ) \\ ⋮ \\ {h}_{l} ( n - K + 1 ; a )\end{matrix} ] a = [ \begin{matrix}{h}_{l} ( n + 1 ; a ) \\ {h}_{l} ( n ; a ) \\ ⋮ \\ {h}_{l} ( n - K + 2 ; a )\end{matrix} ] .$$

Training can happen across Tx antennas. The predictor coefficients are roughly the same across Tx antennas and subbands. The LCP vector a is assumed, for simplicity, to be constant across all Z multipaths (though not necessary).

In one embodiment, a prediction is provided as shown below.

ĥₗ(n+1;a)=hₗ(n;a) a typically happens after the N₁ time-domain sample instants.

In one embodiment, a feedback to BS is provided.

Quantized LPC ā. (optional). Quantized channel error value ēₗ(n;a) for n>N₁. Feedback of ēₗ(n;a) is assumed to take lesser bits than feedback of h̅ₗ(n;a)−h̅ₗ(n−1;a). (Need to be verified by simulations, but generally prediction error is less than error w.r.t. previous sample).

In one embodiment, computing ēₗ(n;a) is provided as shown below.

For the first N₁ samples (n≤N₁), h̅ₗ(n;a) is fed back as usual. For n>N₁, h̅ₗ(n;a)=a̅h̅ₗ(n−1;a) and eₗ(n;a)=hₗ(n;a)−a̅h̅ₗ(n−1;a), feed back ēₗ(n;a). The BS (200) computes ĥₗ(n;a)=ēₗ(n;a)+a̅h̅ₗ(n−1;a).

In one embodiment, LCP (other forms of prediction) is provided as shown below.

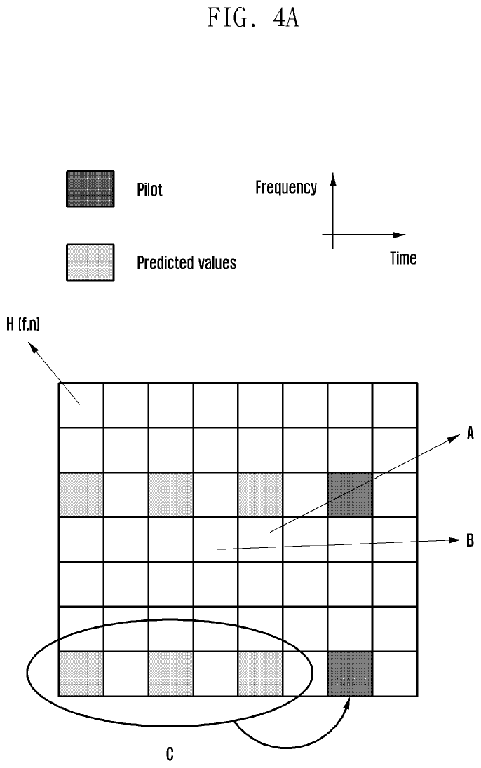

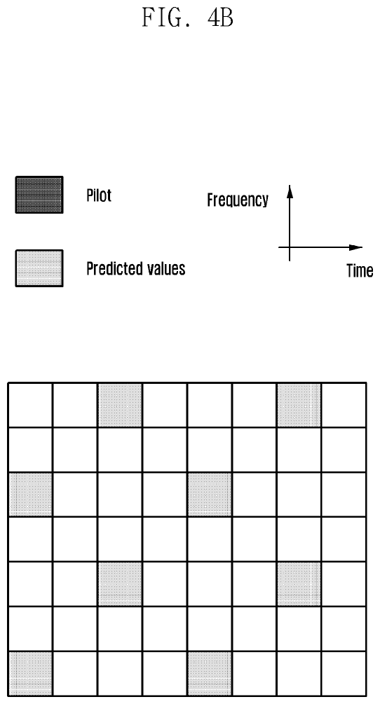

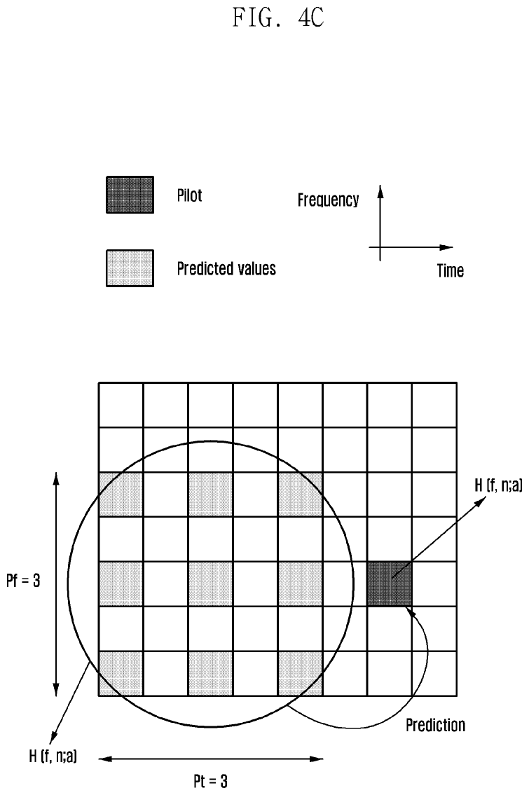

FIG. 4A and FIG. 4B illustrate an example of LCP. At (A), the BS (200) determines channel using H(n)=h(n). It can also use 2D channel prediction using neighbouring pilot symbols across frequency/time at this instant and before this instant to determine the channel here. At (B), the BS (200) determines channel here using time domain interpolation, or 2D channel prediction. At (C), prediction can also happen in frequency domain along a given subcarrier across time. Pilot locations can be diamond shape as well, not necessarily rectangular (as depicted in FIG. 4B).

In one embodiment, LCP (2D prediction) is provided as shown below.

FIG. 4C illustrates an example of 2D-LCP. Pₜ is a prediction order in time domain, and depends on coherence time. P_{f} is prediction order in frequency domain, which can be done using neighboring subbands, and depends on coherence bandwidth. The frequency domain correlation can be harnessed, in addition to time domain, reduces prediction error and hence the feedback. The LCP coefficients are roughly constant across subbands, antennas and small durations of time as it is mainly dependent on Doppler frequency. The LCP coefficient vector a₁ is a PₜP_{f}×1 vector.

In one embodiment, a linear channel prediction is provided as shown below.

LCP equation for 2D case is

$$[ \begin{matrix}H ( {f}_{1} , n ; a ) \\ H ( {f}_{2} , n ; a ) \\ ⋮ \\ H ( {f}_{N 3} , n ; a )\end{matrix} ] {a}_{1} = [ \begin{matrix}H ( {f}_{1} , n ; a ) \\ H ( {f}_{2} , n ; a ) \\ ⋮ \\ H ( {f}_{N 3} , n ; a )\end{matrix} ]$$

where N3>PₜP_{f}. Training can happen at more than one time instant n and also across antennas a. Coefficients can be learnt using neural networks like RNN also.

In one embodiment, Doppler coefficients are provided as shown below.

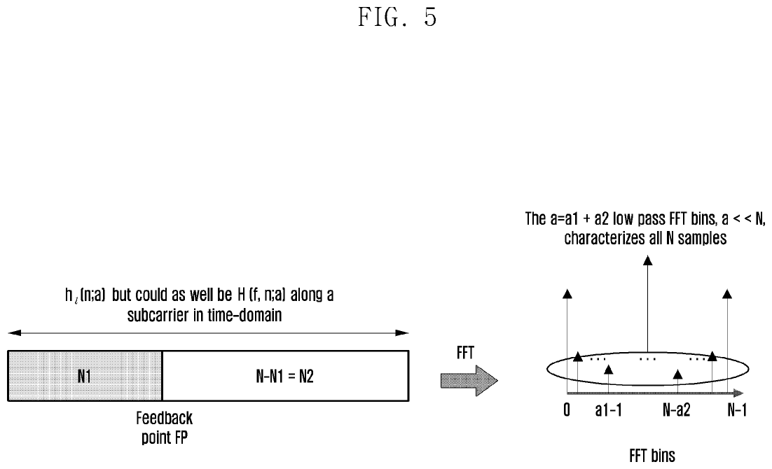

For the first N₁ points, the “a” low-pass FFT bins from the N₁ samples are learned and feedback to the BS (200) at feedback point. The N₁ samples come from channel estimation of CSI-RS. For the next N₂ samples (where N₂=N−N₁), the signal is predicted using the quantized ‘a’ low pass FFT bins, subtracted from the actual value (assuming CSI-RS is present) and the error is feedback to the BS (200). Alternatively, if no CSI-RS here and just BS (200) use the reconstructed signal over this region. The a=a₁+a₂ low pass FFT bins, a<<N, characterizes all N samples. This process is depicted in FIG. 5. Here N1 samples belong to first or observation window and N2 samples belong to second or prediction window.

For n≤N₁ and assuming N₁≥a Doppler coefficients are computed as:

$$\frac{1}{N} [ {f}_{0}^{*} ( 0 : {N}_{1} - 1 ) … {f}_{{a}_{1} - 1}^{*} ( 0 : {N}_{1} - 1 ) {f}_{N - {a}_{2}}^{*} ( 0 : {N}_{1} - 1 ) … {f}_{N - 1}^{*} ( 0 : {N}_{1} - 1 ) ] {d}_{l} = [ \begin{matrix}{h}_{l} ( o ) \\ ⋮ \\ {h}_{l} ( {N}_{1} - 1 )\end{matrix} ] .$$

In such equation, dₗ is a×1 vector of Doppler coefficients fed back to the BS (200) and fᵢ is the ith column of N×N FFT matrix.

For n>N₁, hₗ(n) as:

$$\frac{1}{N} [ {f}_{0}^{*} ( {N}_{1} : end ) … {f}_{{a}_{1} - 1}^{*} ( {N}_{1} : end ) {f}_{N - {a}_{2}}^{*} ( {N}_{1} : end ) … {f}_{N - 1}^{*} ( {N}_{1} : end ) ] {\overline{d}}_{l} = [ \begin{matrix}{\hat{h}}_{l} ( {N}_{1} ) \\ ⋮ \\ {\hat{h}}_{l} ( N - 1 )\end{matrix} ] .$$

The UE (100) feeds back d̅ₗ to BS at FP along with ēₗ(n) where eₗ (n)=hₗ(n)−ĥₗ(n). The BS (200) computes hₗ(n) as ĥₗ(n)+ēₗ(n). Alternatively, if there is no CSI-RS during the N₂ samples, the BS (200) just uses ĥₗ(n).

In one embodiment, 2D-FFT is provided as shown below.

The channel varies slowly in both time and frequency. The Doppler component method can also be extended to two dimensions (time and frequency) and based on 2D-FFT method.

In one embodiment, Kalman filters are provided as shown below.

For fading, Kalman estimators give MMSE estimates if LCP coefficients, channel predictor error variance and error variance associated with observation are known. Here, the observation is quantized and the observation noise is quantization noise. If the feedback channel predictor error variance and quantization noise variance along with LPC coefficients are feedback, the BS (200) can estimate the channel more accurately (overcomes quantization loss). Since Kalman does prediction and correction as against the prediction method, which does only prediction, Kalman can have low prediction orders than prediction method. N₂ can be bigger for Kalman method than channel prediction method, thereby having lesser feedback.

In one embodiment, a feedback of CSI is provided.

All channel feedback H(f,n) or hₗ(n) are per link (Tx-Rx) or per antenna. For simplicity, one layer is assumed. This may consume large feedback even with LCP. So W₁ W₂ domain is considered. The relationships between H(f,n) or hₗ(n) and elements of W₁ W₂ are determined. Let G be an estimate of channel matrix of dimensions 2N_{T}×N₃×N (2 no. of Tx antennas×no. of subbands×no. of time instants). It is provided that G(:,:,n)=W₁W₂(:,:,n)=W₁W₂(:,:,n)W_{f}. Here G is an approximation of channel matrix such that elements of W₂ correspond to conjugate of channel gains associated with the best set of orthonormal beams, a subset of which are the columns of W₁. W₁, W₂, W₂, W_{f} be extended across multiple time instants (third dimension). W₁ be 2N_{T}×2L (2 no. of Tx antennas×2 no. of beams). W₂ be 2L×N₃×N (2 no. of beams×no. of subbands×no. of time instants). W₂ be 2L×M×N (2 no. of beams×no. of FD compressed elements× no. of time instants). W_{f} is N₃×M matrix.

In one embodiment of option 1 (Rel. 15 W₂ type of feedback), the LPC coefficients of all elements of \tilde{W}₂(:,:,n) are related. W₁^{H}(a,:)G(:,b,n)=W₂(a,b,n). From literature, it is known that LCP of H(f,n)(a₁) for a given f across time instant n is roughly the same across f and antennas. So LPC of W₂(a,b,n) is also a. Only one set of LCP coefficients are feedback and LCP coefficients of all elements of W₂ can be calculated. This is an important aspect for compression.

In one embodiment of Option 2 (Rel. 16 W₂ type of feedback),the LCP coefficients of all elements of \tilde{W}₂(:,:,n) are related. W₁^{H}(a,:)G(:,:,n)W_{f}(:,b)=\tilde{W}₂(a,b,n). From literature, it is known that LCP of H(f,n)(a) for a given f across time instant n is roughly the same across f and antennas. So LPC of \tilde{W}₂(a,b,n). is a. Only one set of LPC coefficients have to be feedback and LPC coefficients of all elements of W₂ can be calculated.

In one embodiment of Option 3, both the BS (200) and UE (100) have access to G(:,:,n) for n≤N₁. So, the BS (200) and the UE (100) can both calculate the LCP coefficients. If there is more than one way of calculating LCP coefficients, the UE(100)/BS (200) just has to signal the method used to the BS (200)/UE (100) and BS (200)/UE (100) can use the same method to calculate LCP coefficients.

In one embodiment, a correlation among elements of W₂ is provided as shown below.

W₁^{H}(a,:)G(:,b,n)=W₂(a,b,n). This corresponds to the ath beam, b^{th} subband at time instant n. W₂(a₁,b,n) and W₂(a₂,b,n) are uncorrelated. This is because W₁^{H}(a₁,:)Wₗ(:,a₂)=0 and E{|G(a,b,n)|²} the channel power is constant as a (antenna index) varies. Intuitively they correspond to different beams. So for time and frequency domain prediction orders Pₜ and P_{f}, the apparatus can predict W₂(a₁,b,n) from

$${W}_{2} ( {a}_{1} , b - \frac{{P}_{f} - 1}{2} , n - 1 ) , … , {W}_{2} ( {a}_{1} , b + \frac{{P}_{f} + 1}{2} , n - 1 ) , … , {W}_{2} ( {a}_{1} , b - \frac{{P}_{f} - 1}{2} , n - {P}_{t} + 1 ) , … , {W}_{2} ( {a}_{1} , b + \frac{{P}_{f} + 1}{2} , n - {P}_{t} + 1 ) .$$

The values used for prediction are captured in a row-vector W₂^{(vec)}(a₁,b,n) (in any order). For the element of W₂ corresponding to the ath beam, bth subband and nth time instant, a linear combination of elements of W₂ corresponding to the ath, subband beams

$$b - \frac{{P}_{f} - 1}{2} to b + \frac{{P}_{f} + 1}{2}$$

and time instants n−Pₜ+1 to n−1 are used. The LCP coefficients associated with all elements of W₂ is one and the same and is a₁ (the same as that which is associated with channel values H(f,n;a)).

In one embodiment, a correlation among elements of \tilde{W}₂ is provided as shown below.

W₁^{H}(a,:)G(:,:,n)W_{f}(:,b)=\tilde{W}₂(a,b,n). This corresponds to the ath beam, bth multipath (or FD component) at time instant n. \tilde{W}₂(a₁,b,n) and \tilde{W}₂(a₂,b,n) are uncorrelated. This is because W₁^{H}(a₁,:)Wₗ(:,a₂)=0 and fading is uncorrelated across antennas. Intuitively they correspond to different beams. \tilde{W}₂(a,b₁,n) and W₂(a,b₂,n) are uncorrelated. This is because W_{f}^{H}(b₁,:)W_{f}(:,b₂)=0 and fading is uncorrelated across antennas, correlation between neighboring subbands is constant across subbands. Intuitively, they correspond to different multipaths in the same beam. So for time domain prediction order Pₜ, it can be predicted that \tilde{W}₂(a,b,n) from \tilde{W}₂(a,b,n−1), . . . , \tilde{W}₂(a,b,n−Pₜ+1). The values used for prediction are captured in a row-vector \tilde{W}₂^{(vec)}(a,b,n). For the element of \tilde{W}₂ corresponding to the ath beam, bth multipath and nth time instant, linear combination of elements of \tilde{W}₂ corresponding to the ath beam is used, multipath b only (as uncorrelated across multipaths) and time instants n−Pₜ+1 to n−1. The LCP coefficients associated with all elements of \tilde{W}₂ is one and the same and is a (the same as that which is associated with channel values hₗ(n;a)).

In one embodiment, LCP for elements of W₂ is provided as shown below.

At each time instant n, both the BS (200) and UE (100) store an estimate of W₂ as \ddot{W}₂. The vector W₂^{(vec)}(a,b,n) is formed by using elements of \ddot{W}₂. For time instants n≤N₁, \ddot{W}₂(a,b,n)=W̅₂(a,b,n), the quantized versions feedback by UE->BS. For n≥N₁. As an example for n=N₁+1. The UE (100) predicts W₂^{(vec)}(a,b,n)āᵢ=Ŵ₂(a,b,n). The UE (100) computes error as e(a,b,n)=W₂ (a,b,n)−Ŵ₂(a,b,n). The UE (100) sends the quantized version ē(a,b,n) to the BS (200). The BS (200) and the UE (100) store \ddot{W}₂(a,b,n)=Ŵ₂(a,b,n)+ē(a,b,n). At feedback point (FP) after the first N1 time instants Pt, Pf, ā₁ are exchanged between BS (200) and UE (100) (Either from BS (200) to UE (100) or from UE (100) to BS (200)). Alternately, at FP, an index of a method to calculate ā₁ from \ddot{W}₂ for time instants n≤N₁ can be signalled between the BS (200) and the UE (100) (both directions).

In one embodiment, LCP of elements of W₂ is provided as shown below.

At each time instant n, both the BS (200) and the UE (100) store an estimate of \tilde{W}₂ as [symbol] . The vector Ŵ₂^{(vec)}(a,b,n) is formed by using elements of [symbol] . For time instants n≤N₁, [symbol] ₂(a,b,n)= [symbol] ₂(a,b,n), the quantized versions feedback provided by the UE (100) to the BS (200). For n≥N₁. As an example for n=N₁+1:
The UE (100) predicts \tilde{W}₂^{(vec)}(a,b,n)ā= [symbol] ₂(a,b,n);
The UE (100) computes error as e(a,b,n)=\tilde{W}₂(a,b,n)− [symbol] ₂(a,b,n);
The UE (100) sends to BS (200) the quantized version ē(a,b,n) and
The BS (200) and the UE (100) store [symbol] ₂(a,b,n)= [symbol] ₂(a,b,n)+ē(a,b,n).

At feedback point (FP) after the first N₁ time instants Pₜ, ā are exchanged between the BS (200) and the UE (100) (either from the BS (200) to the UE (100) or from the UE (100) to the BS). Alternately, at FP, an index of a method to calculate ā from \ddot{W}₂ for time instants n≤N₁ can be signalled between the BS (200) and the UE (100) (both directions).

In one embodiment, Doppler coefficients (1D) is provided as shown below.

For n≤N₁ and assuming N₁≥a compute Doppler coefficients as:

$$\frac{1}{N} [ {f}_{0}^{*} ( 0 : {N}_{1} - 1 ) … {f}_{{a}_{1} - 1}^{*} ( 0 : {N}_{1} - 1 ) {f}_{N - {a}_{2}}^{*} ( 0 : {N}_{1} - 1 ) … {f}_{N - 1}^{*} ( 0 : {N}_{1} - 1 ) ] {d}_{b , a} = [ \begin{matrix}{\tilde{W}}_{2} ( a , b , 0 ) \\ ⋮ \\ {\tilde{W}}_{2} ( a , b , {N}_{1} - 1 )\end{matrix} ]$$

where d_{b,a} is a×1 vector of Doppler coefficients and fᵢ is the ith column of N×N FFT matrix.

For n>N₁, reconstruct \tilde{W}₂(a,b,n) as:

$$\frac{1}{N} [ {f}_{0}^{*} ( {N}_{1} : end ) … {f}_{{a}_{1} - 1}^{*} ( {N}_{1} : end ) {f}_{N - {a}_{2}}^{*} ( {N}_{1} : end ) … {f}_{N - 1}^{*} ( {N}_{1} : end ) ] {\overline{d}}_{b , a} = [ \begin{matrix}{\hat{\tilde{W}}}_{2} ( a , b , {N}_{1} ) \\ ⋮ \\ {\hat{\tilde{W}}}_{2} ( a , b , N - 1 )\end{matrix} ] .$$

The UE (100) feeds back d̅_{b,a} to BS (200) for all b and an along with ē_{b,a}(n) where e_{b,a}(n)=Ŵ₂(a,b,n)− [symbol] ₂(a,b,n). The BS (200) computes \tilde{W}₂(a,b,n) as [symbol] ₂(a,b,n)+ē_{b,a}(n). Alternatively, if there is no CSI-RS during the N₂ samples, the BS just uses. [symbol] ₂(a,b,n).

In one embodiment, Doppler-delay coefficients (2D) is provided.

There are N₃ subbands and N samples. The 2D-FFT of elements of W₂ for the bth subband and ath beam and nth time instant (as b and n vary) is defined as:

$${W}_{2}^{( F )} ( p , q ; a ) = {\sum }_{b = 0}^{{N}_{3}} {\sum }_{n = 0}^{N - 1} {W}_{2} ( a , b , n ) {e}^{- j 2 π ( \frac{pb}{{N}_{3}} + \frac{qn}{N} )} {W}_{2} ( a , b , n ) = \frac{1}{{NN}_{3}} {\sum }_{b = 0}^{{N}_{3}} {\sum }_{n = 0}^{N - 1} {W}_{2}^{( F )} ( p , q ; a ) {e}^{j 2 π ( \frac{pb}{{N}_{3}} + \frac{qn}{N} )} .$$

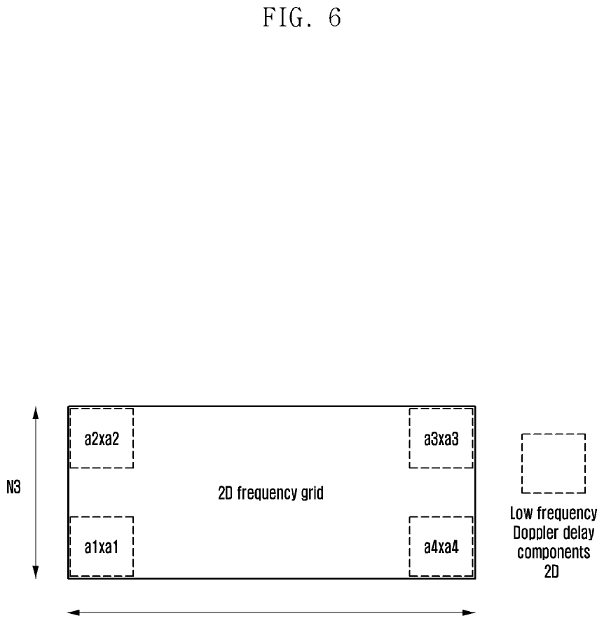

Let the vector equivalent of matrix F be denoted by vec(F). Low frequency components of W₂^{(F)}(p,q;a) may be used for learning/prediction. FIG. 6 depicts the low frequency Doppler delay components in a 2D frequency grid.

In one embodiment, Doppler coefficients (2D) is provided as shown below.

The matrix F_{p,q} is defined, whose (b, n)^{th} element is given by

$$\frac{1}{{NN}_{3}} {e}^{j 2 π ( \frac{pb}{{N}_{3}} + \frac{qn}{N} )} .$$

In all there are a=a₁²+a₂²+a₃²+a₄² 2D-low frequency delay-Doppler coefficients. For n≤N₁ and assuming N₁≥a compute Doppler coefficients as:

[vec(F_{0,0}(:,0:N₁−1)) . . . vec(Fₐ_{₁}_{-1,a}_{₁}₋₁(:,0:N₁−1)) . . . vec(F_{N-a}_{₃}_{,N}_{₃}₋ₐ_{₃}(:,0:N₁−1)) . . . vec(F_{N-1,N}_{₃}₋₁(:,0:N₁−1))]dₐ=vec(W₂(a,:,0:N₁−1))

where dₐ is a×1 vector of Delay-Doppler coefficients.

For n>N₁, W₂(a,b,n) is reconstructed as

$$[ \begin{matrix}vec ( {F}_{0 , 0} ( : , {N}_{1} : end ) ) … vec ( {F}_{{a}_{1} - 1 , {a}_{1} - 1} ( : , {N}_{1} : end ) ) … vec ( {F}_{N - {a}_{3} , {N}_{3} - {a}_{3}} ( : , {N}_{1} : end ) ) … \\ vec ( {F}_{N - 1 , {N}_{3} - 1} ( : , {N}_{1} : end ) )\end{matrix} ] \overline{{d}_{a}} = vec ( {W}_{2} ( a , : , {N}_{1} : end ) )$$

The UE (100) feeds back d̅ₐ to BS along with ē_{b,a}(n) where e_{b,a}(n) W₂(a,b,n)−Ŵ₂(a,b,n). The BS (200) computes W₂(a,b,n) as Ŵ₂(a,b,n)+ē_{b,a}(n). Alternatively, if there is no CSI-RS during the N₂ samples, BS just uses. Ŵ₂(a,b,n).

The above techniques applies compression to both subbands and time and is a 2D compression via FFT. The apparatus can alternatively first compress via subbands and then the compressed subband coefficients can be further compressed along time. This is called as provided compression algorithm or PCA. In the present disclosure, the PCA is provided and then later its variants are provided.

It denotes the Ŵ₂ matrix of earlier releases (up to Release 17) at the i^{th} time instant (For Release 18 there are N₄ time instants—These time instants can lie in observation or prediction window but it may be assumed that each time instant has an associated channel and associated W₁ and Ŵ₂) as Ŵ_{2,i} (of dimension 2L×M). There are M delays (for the elements of Ŵ₂) that are the result of compressing N₃ subbands (for the elements of W₂).

For each beam b do the following (note there are 2L beams, L per polarization, each associated with a column of W₁, called as spatial beam matrix).

For each delay d corresponding to the beam do the following:

Compute the N₄×1 vector x^{(b,d)} corresponding to the b^{th} beam and d^{th} delay as x^{(b,d)} [\tilde{W}_{2,1}(b,d) . . . \tilde{W}_{2,N}_{₄}(b,d)]^{T}, T is the transpose operation. This is compressed to a D×1 vector, called as compressed Doppler coefficient precoder vector, x̅^{(b,d)}=Wₜ^{(b,d)+}x^{(b,d)} where x⁺ is the pseudo-inverse of x. Wₜ^{(b,d)} is the Doppler time domain basis matrix for the bth beam and d^{th} delay;

End of delay loop; and

End of beam loop.

First variant for compression technique (PCA): If the Wₜ^{(b,d)} is constant across beams and delays (in spatial and frequency domains) then the apparatus can have one compression that is feedback as follows.

W₁ of dimension N_{T}×2L, W_{f} of dimension N₃×M, Wₜ of dimension N₄×D, \tilde{W}₂ of dimension 2L×MD, W_{f,t} of dimension N₃N₄×MD. N_{T}=2N₁N₂ is number of transmit antennas and D<<N₄ and M<<N₃ implying compression in frequency and time domains. Wₜ^{(b,d)} can be identity matrix, implying no compression in time-domain for that beam and delay.

W_{f,t} is kron(W_{f}, Wₜ) called as joint Doppler-time frequency/delay domain basis matrix. Kron is Kronecker operation of matrices:

\tilde{W}₂ is formed as

$${\tilde{W}}_{2} = [ \begin{matrix}{\overline{x}}^{( 1 , 1 ) T} & … & {\overline{x}}^{( 1 , M ) T} \\ ⋮ & … & ⋮ \\ {\overline{x}}^{( 2 L , 1 ) T} & … & {\overline{x}}^{( 2 L , M ) T}\end{matrix} ]$$

called as compressed Doppler coefficient precoder matrix.

So if the final precoders are stacked column-wise, such that precoders are stacked first by time and then by subband (i.e., for a given subband stack up for all time instants and do the same for other subbands) and if this precoder matrix is called as, and have W=W₁\tilde{W}₂W_{f,t}^{H}.

In one embodiment, a second variant for compression technique (PCA) is provided as shown below.

If the Wₜ^{(b,d)} is not constant across beams and delays (in spatial and frequency domains) then all Wₜ^{(b,d)} and x̅^{(b,d)} are reported for all beams b and delays d. As regards Wₜ^{(b,d)} enough information is only reported so that gNB (BS) can reconstruct Wₜ^{(b,d)}. Also W₁ is reported.

In some cases, for a given beam b and delay d, Wₜ^{(b,d)} may mean a selected submatrix (consisting of selected columns only) of a Doppler basis matrix Wₜ in which case for each beam b and d, only the selected column information is reported for Wₜ^{(b,d)}.

In one embodiment, third variant for compression technique (PCA) is provided.

PCA variant 1-2 computed delays \tilde{W}_{2,i} for each time instant i. For a given beam b and delay d, it accumulated N₄ values and compressed it in time.

In this variant, W_{2,i} that is the Release-15/16/17 matrix W₂ associated with subbands at time instant i is provided. It takes the N4 values corresponding to a beam b and subband s, compress it in a time domain, and then the compressed values are further compressed across subbands using an appropriate basis (example FFT). The final compressed values are feedback.

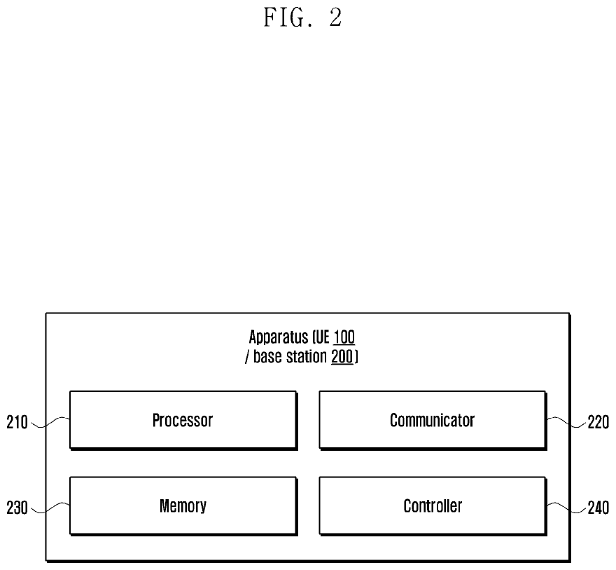

FIG. 2 illustrates an example of hardware components of an apparatus (i.e., UE (100) or base station (200)) according to the embodiments as disclosed herein. In an embodiment, the apparatus includes a processor (210), a communicator (220), a memory (230) and a CSI controller (240). The processor (210) is coupled with the communicator (220), the memory (230) and the CSI controller (240).

In an embodiment, the CSI controller (240) transmits the pilot symbol over the first window and receives at least one of the first type feedback and a second type feedback from the UE (100) at an end of the first window or after the first window. The CSI controller (240) receives the compressed CSI feedback based on the predefined precoder weights in the first window or the second window. Based on the at least one received feedback information (e.g., first type feedback and second type feedback), the CSI controller (240) computes and predicts the at least one precoder weight for the UE (100) in at least one time instant in the second window for at least one sub-band of the UE (100). Further, the CSI controller (240) manages the received CSI feedback compression based on the at least one predicted precoder weight in the second window.

In another embodiment, the CSI controller (240) estimates at least one channel for one of the set of sub-carriers or at least one sub-band or at least one delay or at least one beam delay for a selected time instant in the first window. Further, the CSI controller (240) estimates at least one precoder weight for the selected time instant across the at least one sub-band or delay for the selected time instant in the first window. Further, the CSI controller (240) predicts a value of a quantity in the selected time instant across at least one sub-band or delay in a second window based on a linear combination or a non-linear combination of quantities in one or more dimensions in the first and/or second window, wherein the linear combination or non-linear combination (learning coefficient) is learned across a plurality of candidate values in the first window. Further, the CSI controller (240) manages the CSI feedback compression in the wireless network (300) based on the predicted value of the quantity.

In another embodiment, the CSI controller (240) estimates at least one channel for a set of sub-carriers or at least one sub-band or delays or beam delays for a selected time instant in the first window. Further, the CSI controller (240) estimates at least one precoder weight for the selected time instant across the at least one sub-band or delay for the selected time instant in the first window. Further, the CSI controller (240) determines an output over a period of time in a second window by performing spectral estimation associated with the quantity in the first window, where the output of the spectral estimation is an n-dimensional frequency component and an amplitude associated with the n-dimensional frequency component. Based on the output, the CSI controller (240) estimates the value of the quantity in the selected time instant in the second window. Based on the estimated value of the quantity, the CSI controller (240) manages the CSI feedback compression in the wireless network (300).

In another embodiment, the CSI controller (240) compresses at least one precoder at various time instants across sub-bands or delays at the UE (100) in at least one of the first window and the second window. Further, the CSI controller (240) sends feedback containing information at least one compressed precoder to the base station (200).

The CSI controller (240) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 2 shows various hardware components of the apparatus (200) but it is to be understood that other embodiments are not limited thereon. In other embodiments, the apparatus (200) may include less or more number of components. Further, the labels or names of the components are used only for illustrative purpose and does not limit the scope of the present disclosure. One or more components can be combined together to perform same or substantially similar function in the apparatus (200).

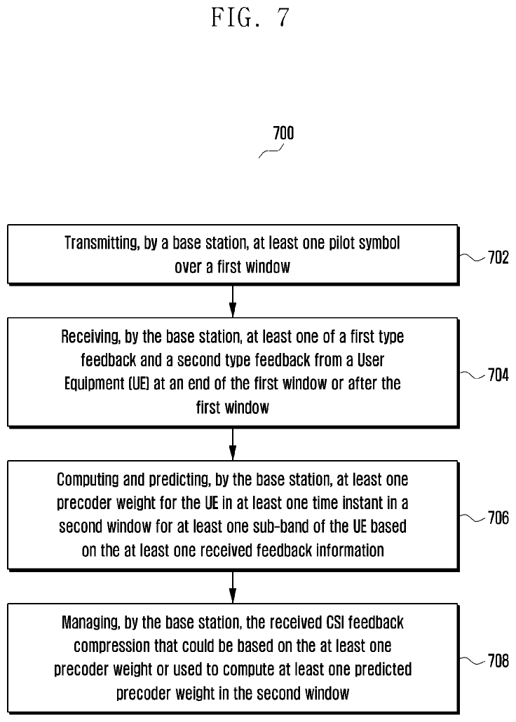

FIG. 7 illustrates a flow chart (700) of a method for managing the CSI feedback compression in the wireless network (300) according to embodiments as disclosed herein. The operations (702-708) are handled by the CSI controller (240).

At 702, the method includes transmitting the at least one pilot symbol over the first window. At 704, the method includes receiving at least one of the first type feedback and the second type feedback from the UE (100) at an end of the first window or after the first window. At 706, the method includes computing and predicting at least one precoder weight for the UE (100) in at least one time instant in the second window for at least one sub-band of the UE (100) based on the at least one received feedback information. At 708, the method includes managing the received CSI feedback compression that could be based on the at least one precoder weight or used to compute at least one predicted precoder weight in the second window.

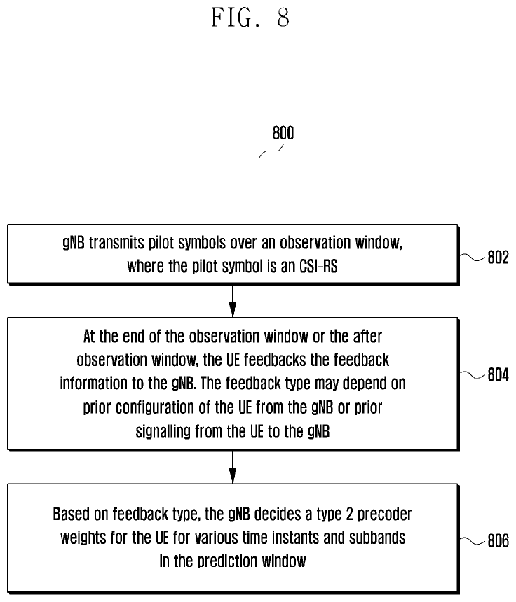

FIG. 8. illustrates an example flow chart (800) of a method for managing the CSI feedback compression in the wireless network (300) according to embodiments as disclosed herein.

At 802, the gNB transmits the pilot symbols over the observation window, where the pilot symbol is an CSI-RS. At 804, at the end of the observation window or after the observation window, the UE (100) feedbacks the feedback information to the gNB. The feedback type may depend on prior configuration of the UE (100) from the gNB or prior signaling from the UE (100) to the gNB. At 806, based on the feedback type, the gNB decides a type 2 precoder weights for the UE (100) for various time instants and subbands in the prediction window.

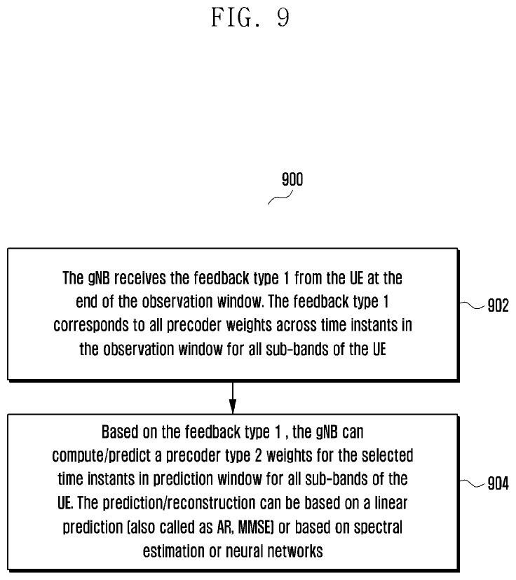

FIG. 9. illustrates an example flow chart (900) of a method for determining the first feedback type while managing the CSI feedback compression in the wireless network (300) according to embodiments as disclosed herein.

At 902, the gNB receives the feedback type 1 from the UE (100) at the end of the observation window. The feedback type 1 corresponds to all precoder weights across time instants in the observation window for all sub-bands of the UE (100). At 904, based on the feedback type 1, the gNB can compute/predict the precoder type 2 weights for the selected time instants in the prediction window for all sub-bands of the UE (100). The prediction/reconstruction can be based on a linear prediction (also called as AR, MMSE) or based on spectral estimation or the neural networks.

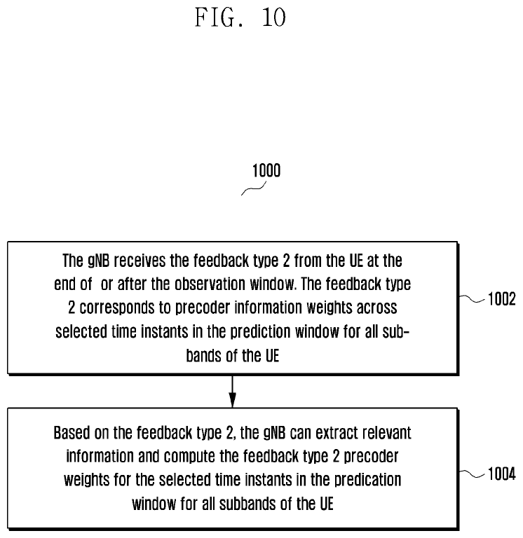

FIG. 10. illustrates an example flow chart (1000) of a method for determining the second feedback type while managing the CSI feedback compression in the wireless network (300) according to embodiments as disclosed herein.

At 1002, the gNB receives the feedback type 2 from the UE (100) at the end of or after the observation window. The feedback type 2 corresponds to precoder information weights across selected time instants in the prediction window for all sub-bands of the UE (100). At 1004, based on the feedback type 2, the gNB can extract relevant information and compute the feedback type 2 precoder weights for the selected time instants in the prediction window for all subbands of the UE (100).

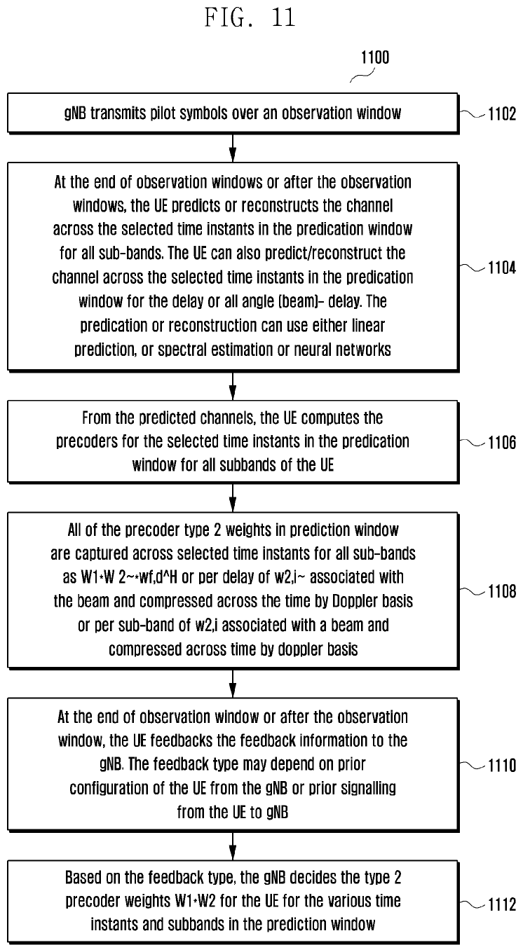

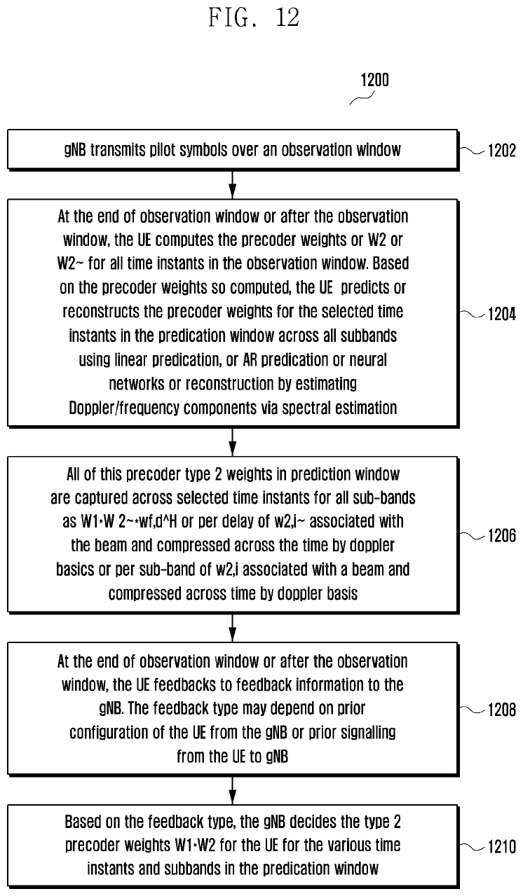

FIG. 11 and FIG. 12. illustrate example flow charts (1100 and 1200) of a method for determining a precoder weights while managing the CSI feedback compression in the wireless network (300) according to embodiments as disclosed herein.

As shown in FIG. 11, at 1102, the gNB transmits the pilot symbols over the observation window. At 1104, at the end of observation windows or after the observation windows, the UE (100) predicts or reconstructs the channel across the selected time instants in the prediction window for all sub-bands. The UE (100) can also predict/reconstruct the channel across the selected time instants in the prediction window for the delay or all angle (beam) delay. The prediction or reconstruction can use either linear prediction, or spectral estimation or the neural networks. At 1106, from the predicted channels, the UE (100) computes the precoders for the selected time instants in the prediction window for all subbands of the UE (100).

At 1108, all of the precoder type 2 weights in the prediction window are captured across selected time instants for all sub-bands as W=W₁\tilde{W}₂W_{f,t}^{H} or per delay of \tilde{W}_{2,i} associated with the beam and compressed across the time by Doppler basis or per sub-band of W_{2,i} associated with a beam and compressed across time by the Doppler basis. At 1110, at the end of observation window or after the observation window, the UE (100) feedbacks the feedback information to the gNB. The feedback type may depend on prior configuration of the UE (100) from the gNB or prior signaling from the UE (100) to the gNB. At 1112, based on the feedback type, the gNB decides the type 2 precoder weights W₁W₂ for the UE (100) for the various time instants and subbands in the prediction window.

As shown in FIG. 12, at 1202, the gNB transmits the pilot symbols over the observation window. At 1204, at the end of observation windows or after the observation window, the UE (100) computes the precoder weights or W₂ or \tilde{W}₂ for all time instants in the observation window. Based on the precoder weights so computed, the UE (100) predicts or reconstructs the precoder weights for the selected time instants in the prediction window across all subbands using linear prediction, or AR prediction or neural networks or reconstruction by estimating Doppler/frequency components via spectral estimation.

At 1206, all of this precoder type 2 weights in the prediction window are captured across selected time instants for all sub-bands as W=W₁\tilde{W}₂W_{f,t}^{H} or per delay of Ŵ_{2,i} associated with the beam and compressed across the time by Doppler basis or per sub-band of W_{2,i} associated with a beam and compressed across time by Doppler basis. At 1208, at the end of observation window or after the observation window, the UE (100) feedbacks to the feedback information to the gNB. The feedback type may depend on prior configuration of the UE (100) from the gNB or prior signaling from the UE (100) to the gNB. At 1210, based on the feedback type, the gNB decides the type 2 precoder weights W₁W₂ for the UE (100) for the various time instants and subbands in the prediction window.

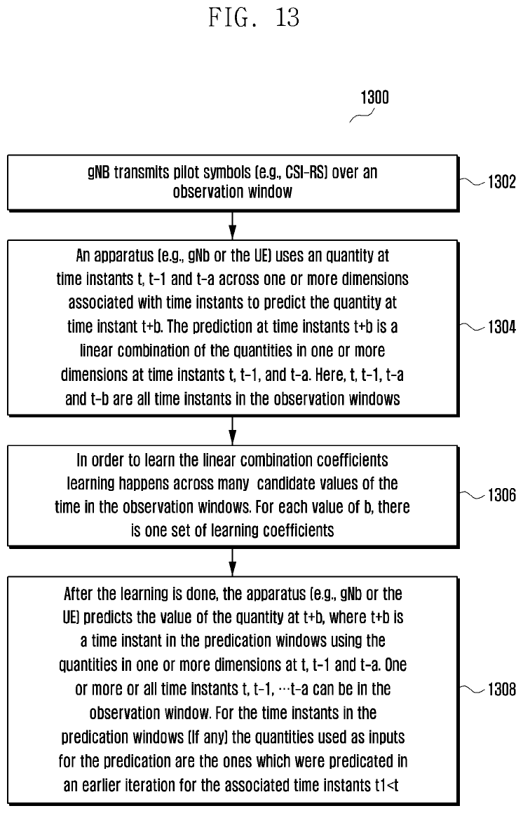

FIG. 13. illustrates an example flow chart (1300) of a method for managing the CSI feedback compression in the wireless network (300) using the linear prediction according to embodiments as disclosed herein.

At 1302, the gNB transmits the pilot symbols over the observation window. At 1304, the apparatus (e.g., gNB or the UE (100)) uses the quantity at time instants t, t−1 and t−a across one or more dimensions associated with time instants to predict the quantity at time instant t+b. The prediction at time instants t+b is a linear combination of the quantities in one or more dimensions at time instants t, t−1, and t−a. Here, t, t−1, t−a and t−b are all time instants in the observation windows.

At 1306, in order to learn the linear combination coefficients learning happens across many candidates across many candidate values of the time in the observation windows. For each value of b, there is one set of learning coefficients. At 1308, after the learning is done, the apparatus (e.g., gNB or the UE (100)) predicts the value of the quantity at t+b, where t+b is a time instant in the prediction windows using the quantities in one or more dimensions at t, t−1 and t−a. One or more or all time instants t, t−1, . . . t−a can be in the observation window. For the time instants in the prediction windows (If any) the quantities used as inputs for the prediction are the ones which were predicated in an earlier iteration for the associated time instants t1<t.

If the quantity is channel, the dimension could be subcarrier/frequency/sub-bands/antennas/delays/beams. If the quantity is an element of w2, the dimensions could be associated beams/sub-bands. If the quantity is an element of w2˜, the dimensions could be associated beams/delays.

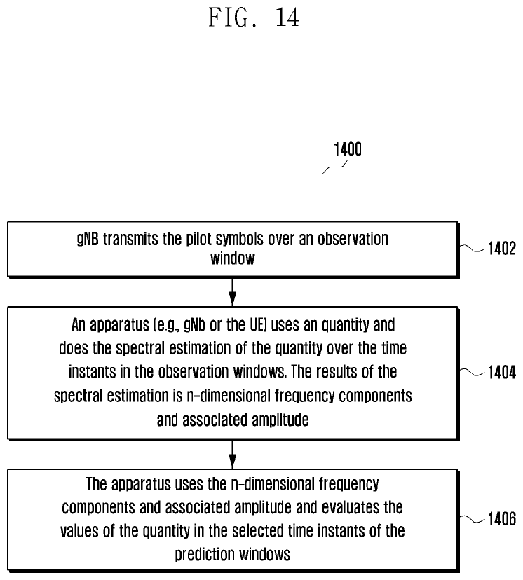

FIG. 14. illustrates an example flow chart (1400) of a method for managing the CSI feedback compression in the wireless network (300) using the spectral estimation according to embodiments as disclosed herein. At 1402, the gNB transmits the pilot symbols over the observation window. At 1404, the apparatus (e.g., gNB or the UE) uses the quantity and does the spectral estimation of the quantity over the time instants in the observation windows. A result of the spectral estimation is n-dimensional frequency components and associated amplitude. At 1406, the apparatus uses the n-dimensional frequency components and associated amplitude and evaluates the values of the quantity in the selected time instants of the prediction windows.

If the quantity is an element of w2 and n=1, a frequency component is across the time (1 dimension). If the quantity is an element of w2 and n=2, a frequency component is across the sub-bands and time (two dimensions). If the quantity is an element of w2˜ and n=1, a frequency component is across the time (one dimension). If the quantity is an element of w2 and n=2, a frequency component is across the delay and time (two dimensions). If the quantity is channel at a subcarrier/sub-band and n=1, the frequency component is across the time (one dimensions). If the quantity is channel at a subcarrier/sub-band and n=2, the frequency component is across the time and the subcarrier/sub-band (two dimensions). If the quantity is channel at a delay and n=1, the frequency component is across the time (one dimension). If the quantity is channel at a delay and n=2, the frequency component is across the time and delay (two dimensions). If the quantity is channel at a delay, angle, and n=1, the frequency component is across the time (one dimension).

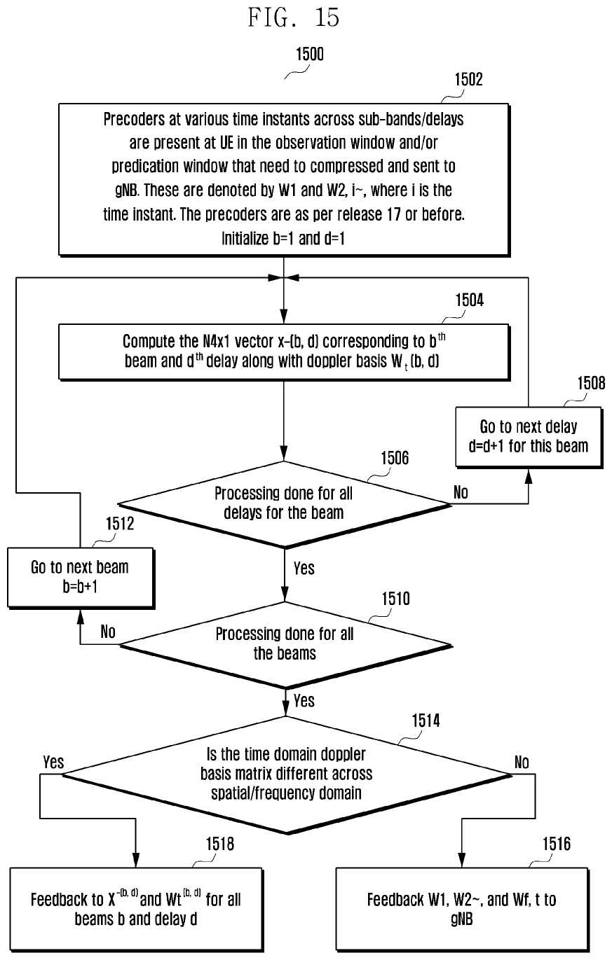

FIG. 15. illustrates an example flow chart (1500) of a method for managing the CSI feedback compression in the wireless network (300) using the Doppler-Delay coefficients according to embodiments as disclosed herein.

At 1502, the precoders at the various time instants across sub-bands/delays are present at the UE (100) in the observation window and/or the prediction window that need to be compressed and sent to the gNB. These are denoted by W₁ and \tilde{W}_{2,i}, where i is the time instant. The precoders are as per release 17 or before. Initialize b=1 and d=1. At 1504, the UE (100) computes the N₄×1 vector x̅^{(b,d)} corresponding to b^{th} beam and d^{th} delay along with Doppler basis Wₜ^{(b,d)}.

At 1506, the method includes determining whether the processing done for all delays for the beam. If the processing is not done for all delays for the beam, at 1508, the method goes to the next delay d=d+1 for the beam. If the processing is done for all delays for the beam, at 1510, the method includes determining whether the processing is done for all the beams. If the processing is not done for all the beams then, at 1512, the method goes to next beam (i.e., b=b+1). If the processing is done for all the beams then, at 1514, method includes determining whether the time domain Doppler basis matrix is different across spatial/frequency domain. If the time domain Doppler basis matrix is not different across spatial/frequency domain then, at 1516, the method includes feedbacking W₁,\tilde{W}₂,W_{f,t}^{H} (Here \tilde{W}₂ is as per [00109]) to the gNB. If the time domain doppler basis matrix is different across the spatial/frequency domain then, at 1518, the method includes feedbacking to x̅^{(b,d)} and Wₜ^{(b,d)} for all beams b and delay d.

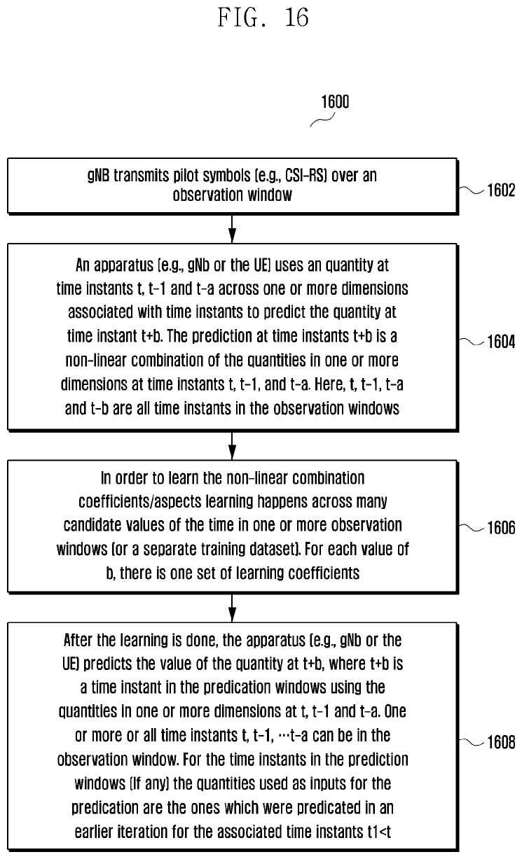

FIG. 16. illustrates an example flow chart (1600) of a method for managing the CSI feedback compression in the wireless network (300) using the non-linear prediction or a neural network according to embodiments as disclosed herein.

As shown in FIG. 16, at 1602, the gNB transmits the pilot symbols (e.g., CSI-RS) over the observation window. At 1604, the apparatus (e.g., gNB or the UE) uses the quantity at time instants t, t−1 and t−a across one or more dimensions associated with time instants to predict the quantity at time instant t+b. The prediction at time instants t+b is a non-linear combination of the quantities in one or more dimensions at time instants t, t−1, and t−a. Here, t, t−1, t−a and t−b are all time instants in the observation windows. At 1606, in order to learn the non-linear combination coefficients/aspects learning happens across many candidate values of the time in one or more observation windows (or a separate training dataset).

For each value of b, there is one set of learning coefficients. At 1608, after the learning is done, the apparatus (e.g., gNB or the UE) predicts the value of the quantity at t+b, where t+b is a time instant in the prediction windows using the quantities in one or more dimensions at t, t−1 and t−a. One or more or all time instants t, t−1, . . . t−a can be in the observation window. For the time instants in the prediction windows (If any) the quantities used as inputs for the predication are the ones which were predicated in an earlier iteration for the associated time instants t1<t.

The various actions, acts, blocks, steps, or the like in the flow charts (700-1600) may be performed in the order presented, in a different order or simultaneously. Further, in some embodiments, some of the actions, acts, blocks, steps, or the like may be omitted, added, modified, skipped, or the like without departing from the scope of the present disclosure.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a base station in a wireless network, the method comprising:
transmitting at least one pilot symbol over a first window;
receiving, from a user equipment (UE), at least one of a first type feedback or a second type feedback at an end of the first window or after the first window;
receiving a compressed channel state information (CSI) feedback based on predefined precoder weights in the first window or a second window;
computing a prediction of at least one precoder weight for the UE in at least one time instant in the second window for at least one sub-band of the UE based on the at least one of the first type feedback or the second type feedback; and
managing the received CSI feedback compression based on the at least one predicted precoder weight in the second window.

2. The method as claimed in claim 1, wherein computing a prediction of the at least one precoder weight for the UE in the at least one time instant in the second window for the at least one sub-band of the UE based on the at least one CSI feedback comprises:
extracting information from the second type feedback; and
computing a prediction of the at least one precoder weight for the UE in the at least one time instant in the second window for the at least one sub-band of the UE based on the extracted information.

3. The method as claimed in claim 1, wherein the at least one of the first type feedback or the second type feedback is determined based on at least one of a prior configuration of the UE received from the base station or a prior signaling transmitted from the UE to the base station.

4. The method as claimed in claim 1, wherein:
the first type feedback corresponds to all precoder weights across the at least one time instants in the first window for all sub-bands of the UE;
the first window is an observation window and the second window is a prediction window;
the at least one pilot symbol comprises a channel state information reference signal (CSI-RS); and
the CSI feedback compression is managed in a Doppler domain.

5. The method as claimed in claim 1, wherein the at least one precoder weight for the UE is predicted in the second window based on at least one of a linear prediction technique, a spectral estimation technique, or a neural network (NN).

6. The method as claimed in claim 1, further comprising, to determine the second type feedback,:
computing a channel across the at least one time instant in the first window for at least one delay, a sub-band, a sub-carrier, or a beam delay;
predicting the channel using the computed channel in the first window across the at least one time instant in the second window for the at least one delay, the sub-band, the sub-carrier, or the beam delay, wherein the channel across the at least one time instant in the second window for the at least one delay, the sub-carrier, the sub-band, or an angle delay is predicted based on at least one of a liner prediction technique, a spectral estimation technique, or a neural network (NN);
computing a precoder for the at least one time instant in the second window for all the sub-bands of the UE; and
obtaining at least one precoder weight across the at least one time instant in the second window for all the sub-bands of the UE in a compressed format.

7. The method as claimed in claim 1, further comprising, to determine the second type feedback:
predicting the precoder across the at least one time instant in the second window for at least one delay or a sub-band, wherein the precoder across the at least one time instant in the second window for the at least one delay or the sub-band is predicted from precoders in the first window based on at least one of a liner prediction technique, a spectral estimation technique, or a neural network (NN); and
obtaining, by the base station, the at least one precoder weight across the at least one time instant in the second window for all the sub-bands of the UE in a compressed format.

8. A method of an apparatus in a wireless network, the method comprising:
estimating at least one channel for one of a set of sub-carriers, at least one sub-band, at least one delay, or at least one beam delay for a selected time instant in a first window;
estimating at least one precoder weight for the selected time instant across the at least one sub-band or the at least one delay for the selected time instant in the first window;
predicting a value of a quantity in the selected time instant across at least one subband or the at least one delay in a second window based on a linear combination or a non-linear combination of quantities in one or more dimensions in the first or second window, wherein the linear combination or non-linear combination is learned across a plurality of candidate values in the first window; and
managing a channel state information (CSI) feedback compression in the wireless network based on the predicted value of the quantity.

9. The method as claimed in claim 8, wherein at least one pilot symbol comprises a channel state information reference signal (CSI-RS), and wherein the CSI feedback compression is managed in a Doppler domain.

10. The method as claimed in claim 8, wherein the value of the quantity is determined based on at least one of subcarriers, sub-bands, frequency, delays, beam delays, or an antenna, wherein the value of the quantity is the precoder weight for the beam in the sub-bands or the delays.

11. The method as claimed in claim 8, wherein the apparatus comprises at least one of a user equipment (UE) or a base station.

12. A method of an apparatus in a wireless network, the method comprising:
estimating at least one channel for a set of sub-carriers, at least one sub-band, delays, or beam delays for a selected time instant in a first window;
estimating at least one precoder weight for the selected time instant across the at least one sub-band or delay for the selected time instant in the first window;
determining an output over a period of time in a second window by performing spectral estimation associated with a quantity in the first window, where the output of the spectral estimation is an n-dimensional frequency component and an amplitude associated with the n-dimensional frequency component;
estimating a value of the quantity in the selected time instant in the second window based on the output; and
managing a channel state information (CSI) feedback compression in the wireless network based on the estimated value of the quantity.

13. The method as claimed in claim 12, wherein at least one pilot symbol comprises a channel state information reference signal (CSI-RS), and wherein the CSI feedback compression is managed in a doppler domain.

14. The method as claimed in claim 12, wherein:
the apparatus further comprises at least one of a user equipment (UE) or a base station;
when the quantity is an element of w2 and n=1, a frequency component is across the time;
when the quantity is an element of w2 and n=2, a frequency component is across the sub-bands and time;
when the quantity is an element of w2˜ and n=1, a frequency component is across the time;
when the quantity is an element of w2 and n=2, a frequency component is across the delay and time;
when the quantity is channel at a subcarrier/sub-band and n=2, the frequency component is across the time and the subcarrier/sub-band;
when the quantity is channel at a subcarrier/sub-band and n=1, the frequency component is across the time;
when the quantity is channel at a delay and n=1, the frequency component is across the time;
when the quantity is channel at a delay and n=2, the frequency component is across the time and delay; and
when the quantity is channel at a delay, angle, and n=1, the frequency component is across the time.

15. A method of a user equipment (UE) in a wireless network, the method comprising:
compressing at least one precoder at various time instants across sub-bands or delays at the UE in at least one of a first window or a second window; and
sending at least one compressed precoder to a base station.

16. The method as claimed in claim 15, further comprising:
computing, a vector value corresponding to precoder weights of a beam and a delay across various time instants in at least one of the first window and the second window;
determining that the computed vector value for all delays for the beam are completed;
determining that the computed vector value for all beams are completed;
determining whether a time domain Doppler basis matrix for the various time instants is different across one of a spatial domain, a delay domain, or a frequency domain; and
performing, at least one of following:
feedbacking a first compressed Doppler coefficient precoder vector value based on precoder weights for each beam and subband or delay across the various time instants, a Doppler-time domain basis matrix for each beam and subband or delay associated with the first compressed vector and a spatial beam matrix value associated with all beams in response to determining that the time domain Doppler matrix is different across one of the spatial domain, the delay domain and the frequency domain, or
feedbacking a first compressed Doppler coefficient precoder matrix value based on precoder weights for all beams and subband or delay across the various time instants, a joint Doppler-time frequency or delay domain basis matrix for all beams and subband or delay associated with the compressed Doppler coefficient matrix and the spatial beam matrix value associated with all beams in response to determining that the time domain Doppler matrix is not different across one of the spatial domain, the delay domain and the frequency domain.

17. A base station in a wireless network, the base station comprising:
a processor;
memory; and
a channel state information (CSI) controller, coupled with the processor and the memory, configured to:
transmit at least one pilot symbol over a first window,
receive, from a user equipment (UE), at least one of a first type feedback or a second type feedback at an end of the first window or after the first window,
receive a compressed CSI feedback based on predefined precoder weights in the first window or a second window,
compute and predict at least one precoder weight for the UE in at least one time instant in the second window for at least one sub-band of the UE based on the at least one of the first type feedback or the second type feedback, and
manage the received CSI feedback compression based on the at least one predicted precoder weight in the second window.

18. An apparatus in a wireless communication network, the apparatus comprising:
a processor;
memory; and
a channel state information (CSI) controller, coupled with the processor and the memory, configured to:
estimate at least one channel for one of a set of sub-carriers, at least one sub-band, at least one delay, or at least one beam delay for a selected time instant in a first window,
estimate at least one precoder weight for the selected time instant across the at least one sub-band or the at least one delay for the selected time instant in the first window,
predict a value of a quantity in the selected time instant across at least one sub-band or the at least one delay in a second window based on a linear combination or a non-linear combination of quantities in one or more dimensions of the first or second window, wherein the linear combination or non-linear combination is learned across a plurality of candidate values in the first window, and
manage a CSI feedback compression in the wireless network based on the predicted value of the quantity.

19. An apparatus in a wireless communication network, the apparatus comprising:
a processor;
memory; and
a channel state information (CSI) controller, coupled with the processor and the memory, configured to:
estimate at least one channel for a one of set of sub-carriers, at least one sub-band, delays, or beam delays for a selected time instant in a first window,
estimate at least one precoder weight for the selected time instant across the at least one sub-band or delay for the selected time instant in the first window,
determine an output over a period of time in a second window by performing spectral estimation associated with a quantity in the first window, where the output of the spectral estimation is an n-dimensional frequency component and an amplitude associated with the n-dimensional frequency component,
estimate a value of the quantity in the selected time instant in the second window based on the output, and
manage a CSI feedback compression in the wireless network based on the estimated value of the quantity.

20. A user equipment (UE) in a wireless communication network, the UE comprising:
a processor;
memory; and
a channel state information (CSI) controller, coupled with the processor and the memory, configured to:
compress at least one precoder at various time instants across sub-bands or delays at the UE in at least one of a first window or a second window, and
send at least one compressed precoder to a base station.
